(19) United States
(12) Patent Application Publication
(10) Pub. No.: US 2004/0102123 A1
(43) Pub. Date: May 27, 2004

(54) High strength uniformity nonwoven laminate and process therefor

(76) Inventors: Uyles Woodrow Bowen JR., Canton, GA (US); Steven Wayne Fitting, Acworth, GA (US); Melissa Robyn Gaynor, Woodstock, GA (US); Michael Peter Mathis, Marietta, GA (US); Jeffrey Lawrence McManus, Canton, GA (US); Lisa Ann Schild, Roswell, GA (US)

Correspondence Address: KIMBERLY-CLARK WORLDWIDE, INC., 401 NORTH LAKE STREET, NEENAH, WI, 54956

(21) Appl. No.: 10/301,144

(22) Filed: Nov. 21, 2002

(51) Int. Cl. D04H 3/04; D04H 1/00; D04H 3/00; D04H 5/00; D04H 13/00; B32B 5/26; B32B 27/12; D04H 1/56; D04H 3/16

(52) U.S. Cl. 442/382; 442/394; 442/400; 442/401; 28/102

(57) ABSTRACT

The present invention provides nonwoven laminate materials with high overall uniformity of material properties, particularly tensile strength properties. The present invention also includes methods for forming the nonwoven laminate materials wherein the fiber extrusion and drawing apparati are oriented at a non-right angle with respect to the direction of web production or MD.

### TECHNICAL FIELD

The present invention is related to nonwoven laminate materials having high uniformity of strength properties.

### BACKGROUND OF THE INVENTION

Many of the medical care garments and products, protective wear garments, mortuary and veterinary products, and personal care products in use today are partially or wholly constructed of nonwoven web materials. Examples of such products include, but are not limited to, medical and health care products such as surgical drapes, gowns, face masks, sterilization wrap materials and bandages, protective workwear garments such as coveralls and lab coats, and infant, child and adult personal care absorbent products such as diapers, training pants, swimwear, incontinence garments and pads, sanitary napkins, wipes and the like. For these applications nonwoven fibrous webs provide tactile, comfort and aesthetic properties which can approach those of traditional woven or knitted cloth materials. For many of the applications for nonwoven materials and nonwoven laminate materials strength is an important property. More particularly, high uniformity of strength is often an important property. For applications such as sterilization wrap material used to cover surgical instrument and supplies trays during sterilization, surgical gowns worn by surgical operating room personnel, and disposable protective garments worn in industrial settings, it is very important that the materials be able to protect against biological and chemical contamination. To do this, the materials must have sufficient strength to resist tears or material breaches which would allow entry of contaminants. Because tearing forces may be applied to the nonwoven material in many different directions, not only high strength but high uniformity of strength is needed to better protect against breach of the material. As an example, after being wrapped and sterilized, a nonwoven material-wrapped surgical tray may be handled by various personnel during transport and storage, and at each handling there is presented the opportunity for the nonwoven sterilization wrap material to be breached, potentially admitting contaminants to the sterile contents of the tray. For garments such as nonwoven surgical gowns and nonwoven industrial protective apparel, movements of the wearer's body, particularly at the joints such as at shoulders, elbows and knees, may either simultaneously or sequentially apply forces to the material from many directions. These forces due to movement of the wearer's body can tear the garment, exposing the wearer to biological infectious agents or chemical contaminants.

Nonwoven web materials have a physical structure of individual fibers or filaments which are interlaid in a generally random manner rather than in a regular, repeating and identifiable manner as in knitted or woven fabrics. The fibers may be continuous or discontinuous, and are frequently produced from thermoplastic polymer or copolymer resins from the general classes of polyolefins, polyesters and polyamides, as well as numerous other polymers. In addition, nonwoven fabrics may be used in composite materials in conjunction with other nonwoven layers as in spunbond-meltblown (SM) and spunbond-meltblown-spunbond (SMS) laminate fabrics, and may also be used in combination with thermoplastic films as in spunbond-film (SF) and spunbond-film-spunbond (SFS) laminates.

Typically, nonwoven webs such as spunbond and meltblown nonwoven webs are formed with the fiber extrusion apparatus such as a spinneret or meltblown die oriented in the cross-machine direction or “CD”. That is, the apparatus is oriented at a 90 degree angle with respect to the direction of nonwoven web production. The direction of nonwoven web production is known as the “machine direction” or “MD”. Although, as was stated above, the fibers are laid on the forming surface in a generally random manner, still, because the fibers generally exit the CD oriented fiber extrusion apparatus in a direction substantially parallel to the MD and are pulled in the direction of movement of the forming surface, the resulting nonwoven materials have an overall average fiber directionality wherein a majority of the fibers are oriented in the MD. Such properties as material tensile strength and extensibility, for example, are strongly affected by fiber orientation.

Because of this MD fiber directionality, nonwoven materials usually exhibit a tensile strength variability wherein the tensile strength taken in the MD direction is as high as two or even more times higher than the tensile strength of the material taken in other directions. Therefore, the tensile strength of the nonwoven material in directions other than the MD is much lower, which can result in material compromise or tears when forces are applied against the material in directions other than the MD. One solution to this problem has been to increase the basis weight of the nonwoven materials until the tensile strength in directions other than the MD is finally high enough to withstand most or all of the tearing forces which will be applied against the products in which the nonwoven material is to be used. However, this solution is costly in terms of raw materials and production time and results in products which are more expensive than are otherwise needed. Consequently, there remains a need for nonwoven materials which have high uniformity of properties, particularly strength properties, throughout a wide range of directions, so that products may be made having substantially no “weak” direction, that is, nonwoven materials having high overall tensile strength to basis weight ratios in all directions of the x and y plane of the material.

### SUMMARY OF THE INVENTION

The present invention provides a nonwoven laminate material comprising at least first and second web layers of continuous fibers bonded to form a laminate, wherein the nonwoven laminate material has essentially equal tensile strength in any direction taken within the plane of the laminate material. The nonwoven laminate material may desirably further comprise one or more barrier layers sandwiched between and in face to face relation to the first and second nonwoven web layers of continuous fibers. The barrier layer or layers may desirably be meltspun microfiber layers such as meltblown layers or may be thermoplastic film layers such as breathable film layers. The nonwoven web layers and/or the barrier layer or layers may desirably comprise one or more olefin polymers. The nonwoven laminate material may desirably comprise additives or treatments to impart desired characteristics. The nonwoven laminate material is useful for a broad range of medical care, personal care, and protective wear products such as for example surgical drapes and gowns, face masks and other surgical wear, sterilization wraps, and protective workwear garments.

The present invention also provides a process for forming multi-layer nonwoven laminate material including the steps of providing at least first and second plurality of continuous fibers from first and second sources of continuous fibers, where the continuous fiber sources, i.e. the fiber production apparati, are angled with respect to the direction of material production at about 30 to 60 degrees and about 300 to about 330 degrees, providing at least one layer of barrier material, collecting the first plurality of continuous fibers, the barrier material, and the second plurality of continuous fibers on a moving forming surface to form a multi-layer nonwoven material wherein the barrier material is disposed between the first and second plurality of continuous fibers, and then bonding the multi-layer nonwoven material to form the nonwoven laminate material. The fiber sources will often desirably be oriented at about 45 and about 315 degrees. The barrier material may desirably be a meltblown material unwind roll or may be one or more meltblown forming dies, and the process may also desirably comprise the step of electrostatically charging the continuous fibers.

Further provided herein is a process for forming multi-layer nonwoven laminate material including the steps of providing at least first and second webs of continuous fibers, wherein the first and second webs have each been formed from fiber forming apparatus oriented at an angle with respect to the MD direction of about 30 degrees to about 60 degrees or about 300 degrees to about 330 degrees, inverting one of the webs, providing at least one layer of barrier material disposed between the first web and second webs; and then bonding the first web, the barrier material and the second web together to form the multi-layer nonwoven laminate material. The barrier material may desirably be, for example, breathable films or meltblown layers.

### BRIEF DESCRIPTION OF THE DRAWINGS

FIG. 1 is a partially cut-away schematic perspective view of an embodiment of the nonwoven laminate material.

FIG. 2 is an overhead or top plan view illustrating exemplary orientation with respect to the direction of web production or MD of extrusion and drawing equipment which may be used in the production of the nonwoven laminate material.

FIG. 3 is a top plan view of an exemplary process for producing the nonwoven laminate material of the present invention.

FIG. 4 is a schematic illustration of exemplary medical products fabricated using the nonwoven laminate material of the present invention.

### Definitions

As used herein and in the claims, the term “comprising” is inclusive or open-ended and does not exclude additional unrecited elements, compositional components, or method steps. Accordingly, the term “comprising” encompasses the more restrictive terms “consisting essentially of” and “consisting of”.

As used herein the term “polymer” generally includes but is not limited to, homopolymers, copolymers, such as for example, block, graft, random and alternating copolymers, terpolymers, etc. and blends and modifications thereof. Furthermore, unless otherwise specifically limited, the term “polymer” shall include all possible spatial or geometrical configurations of the material. These configurations include, but are not limited to isotactic, syndiotactic and random symmetries.

As used herein the term “fibers” refers to both staple length and longer fibers and substantially continuous fibers, unless otherwise indicated. As used herein the term “substantially continuous” filament means a filament or fiber having a length much greater than its diameter, for example having a length to diameter ratio in excess of about 15,000 to 1, and desirably in excess of 50,000 to 1.

As used herein the term “monocomponent” fiber refers to a fiber formed from one or more extruders using only one polymer extrudate. This is not meant to exclude fibers formed from one polymer to which small amounts of additives have been added for color, anti-static properties, lubrication, hydrophilicity, etc. These additives, e.g. titanium dioxide for color, are generally present in an amount less than 5 weight percent and more typically about 2 weight percent.

As used herein the term “multicomponent fibers” refers to fibers which have been formed from at least two component polymers, or the same polymer with different properties or additives, extruded from separate extruders but spun together to form one fiber. Multicomponent fibers are also sometimes referred to as conjugate fibers or bicomponent fibers. The polymers are arranged in substantially constantly positioned distinct zones across the cross-section of the multicomponent fibers and extend continuously along the length of the multicomponent fibers. The configuration of such a multicomponent fiber may be, for example, a sheath/core arrangement wherein one polymer is surrounded by another, or may be a side by side arrangement, an “islands-in-the-sea” arrangement, or arranged as pie-wedge shapes or as stripes on a round, oval, or rectangular cross-section fiber. Multicomponent fibers are taught in U.S. Pat. No. 5,108,820 to Kaneko et al., U.S. Pat. No. 5,336,552 to Strack et al., and U.S. Pat. No. 5,382,400 to Pike et al. For two component fibers, the polymers may be present in ratios of 75/25, 50/50, 25/75 or any other desired ratios.

As used herein the term “biconstituent fiber” or “multiconstituent fiber” refers to a fiber formed from at least two polymers, or the same polymer with different properties or additives, extruded from the same extruder as a blend and wherein the polymers are not arranged in substantially constantly positioned distinct zones across the cross-section of the multicomponent fibers. Fibers of this general type are discussed in, for example, U.S. Pat. No. 5,108,827 to Gessner.

As used herein the term “nonwoven web” or “nonwoven material” means a web having a structure of individual fibers or filaments which are interlaid, but not in an identifiable manner as in a knitted or woven fabric. Nonwoven webs have been formed from many processes such as for example, meltblowing processes, spunbonding processes, air-laying processes and carded web processes. The basis weight of nonwoven fabrics is usually expressed in grams per square meter (gsm) or ounces of material per square yard (osy) and the fiber diameters useful are usually expressed in microns. (Note that to convert from osy to gsm, multiply osy by 33.91).

The term “spunbond” or “spunbond nonwoven” refers to a nonwoven fiber or filament material of small diameter fibers that are formed by extruding molten thermoplastic polymer as a plurality of fibers from a plurality of capillaries of a spinneret. The extruded fibers are cooled while being drawn by an eductive or other well known drawing mechanism. The drawn fibers are deposited or laid onto a forming surface in a generally random manner to form a loosely entangled fiber web, and then the laid fiber web is subjected to a bonding process to impart physical integrity and dimensional stability. The production of spunbond fabrics is disclosed, for example, in U.S. Pat. No. 4,340,563 to Appel et al. and U.S. Pat. No. 3,802,817 to Matsuki et al. Typically, spunbond fibers or filaments have a weight-per-unit-length in excess of 2 denier and up to about 6 denier or higher, although finer spunbond fibers can be produced. In terms of fiber diameter, spunbond fibers generally have an average diameter of larger than 7 microns, and more particularly between about 10 and about 25 microns.

As used herein the term “meltblown fibers” means fibers or microfibers formed by extruding a molten thermoplastic material through a plurality of fine, usually circular, die capillaries as molten threads or fibers into converging high velocity gas (e.g. air) streams which attenuate the fibers of molten thermoplastic material to reduce their diameter. Thereafter, the meltblown fibers are carried by the high velocity gas stream and are deposited on a collecting surface to form a web of randomly dispersed meltblown fibers. Such a process is disclosed, for example, in U.S. Pat. No. 3,849,241 to Buntin. Meltblown fibers may be continuous or discontinuous, are generally smaller than 10 microns in average diameter and are often smaller than 7 or even 5 microns in average diameter, and are generally tacky when deposited onto a collecting surface.

As used herein the term “laminate” means a composite material made from two or more layers or webs of material which have been bonded or attached to one another.

As used herein, “thermal point bonding” involves passing a fabric or web of fibers or other sheet layer material to be bonded between a heated calender roll and an anvil roll. The calender roll is usually, though not always, patterned in some way so that the entire fabric is not bonded across its entire surface. As a result, various patterns for calender rolls have been developed for functional as well as aesthetic reasons. One example of a pattern has points and is the Hansen Pennings or “H&P” pattern with about a 30% bond area with about 200 bonds/square inch as taught in U.S. Pat. No. 3, 855,046 to Hansen and Pennings. The H&P pattern has square point or pin bonding areas wherein each pin has a side dimension of 0.038 inches (0.965 mm), a spacing of 0.070 inches (1.778 mm) between pins, and a depth of bonding of 0.023 inches (0.584 mm). The resulting pattern has a bonded area of about 29.5%. Another typical point bonding pattern is the expanded Hansen and Pennings or “EHP” bond pattern which produces a 15% bond area with a square pin having a side dimension of 0.037 inches (0.94 mm), a pin spacing of 0.097 inches (2.464 mm) and a depth of 0.039 inches (0.991 mm). Still another useful point bonding pattern is the expanded RHT pattern as illustrated in U.S. Design Pat. No. 239,566 to Vogt. Other common patterns include a diamond pattern with repeating and slightly offset diamonds and a wire weave pattern looking as the name suggests, e.g. like a window screen. Typically, the percent bonding area varies from around 10% to around 30% of the area of the fabric laminate web. Thermal point bonding imparts integrity to individual layers by bonding fibers within the layer and/or for laminates of multiple layers, point bonding holds the layers together to form a cohesive laminate.

### DETAILED DESCRIPTION OF THE INVENTION

The present invention provides a nonwoven laminate material comprising at least first and second web layers of substantially continuous fibers bonded to form a laminate, wherein the nonwoven laminate material has essentially equal tensile strength in any direction taken within the x-y plane of the laminate material. The nonwoven laminate material may desirably further comprise one or more barrier layers sandwiched between and in face to face relation to the at least first and second nonwoven web layers of continuous fibers. As used herein, “essentially equal tensile strength” for any direction in the plane of the material means that for 180 degree tensile strength testing as described below the tensile strength variation is about 6 percent or less. For certain applications, the tensile strength variation will desirably be about 5 percent or less, and for still others desirably about 4 percent or less. The invention additionally provides a process for making nonwoven laminate material and provides protective fabrics and garments such as sterilization wraps, surgical drapes, gowns, face masks and other surgical wear, and protective workwear garments from the high strength uniformity nonwoven laminate material.

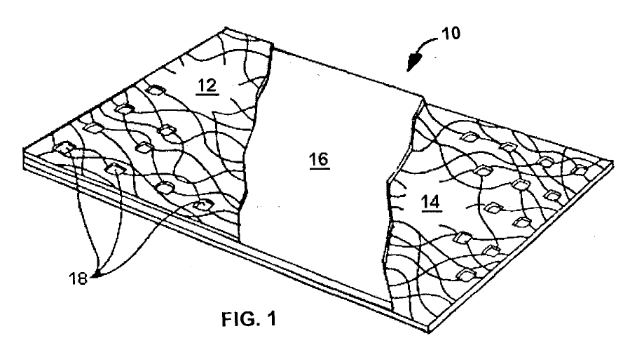

As stated, the nonwoven laminate material of the invention comprises at least a first and second web of continuous fibers, and may desirably further comprise one or more barrier layers sandwiched between and in face to face relation to the first and second web layers of continuous fibers which are bonded to either side of the barrier layer or layers, such as is embodied in the exemplary tri-layer laminate material shown in FIG. 1. FIG. 1 is a schematic only, simply illustrative of one of the types of laminates intended. Generally, such multi-layer nonwoven laminate materials have a basis weight of from about 0.1 osy to 12 osy (about 3 to about 400 gsm), or more particularly from about 0.5 osy to about 5 osy. As shown in FIG. 1, the tri-layer embodiment of the nonwoven laminate material is generally designated 10 and comprises barrier layer 16, which is sandwiched between the nonwoven web layers of continuous filaments designated as 12 and 14. The nonwoven layers of continuous filaments may desirably be spunbond nonwoven layers, and may conveniently be designated as “facing” layers of the barrier layer. The barrier layer 16 may be one or more film layers such as are known in the art. Where nonwoven layers 12 and 14 are spunbond layers and barrier layer 16 is a film, the nonwoven laminate material may conveniently be designated as a spunbond-film-spunbond laminate or “SFS” laminate. Alternatively, the barrier layer may comprise a meltspun microfiber layer such as a meltblown layer to make a spunbond-meltblown-spunbond or “SMS” laminate material as is disclosed in U.S. Pat. No. 4,041,203 to Brock et al., which is incorporated herein in its entirety by reference. Additionally shown in FIG. 1 are exemplary bond points 18 such as may be made by a thermal point bonding process.

As other alternatives, the multilayer nonwoven laminate material may be formed as a laminate comprising multiple layers of barrier material such as for example in a “SMMS” or “SMMMS” laminate material comprising multiple layers of meltspun microfibers. Further, the laminate may comprise facing layers on either side of the barrier layer or layers wherein the facing layers themselves are multiple layers of the nonwoven web layers of continuous fibers. Such a multilayer laminate may be designated “SSFSS” or “SSMSS”. Other combinations are possible. However it should be noted that in order to achieve the benefits of the invention it is important that the facing layers on either side of the barrier layer have similar tensile strength and elongation properties with regard to each other. Therefore, while it is not required that the two facing layers be identical to each other, the more similar the facing layers are in terms of basis weight, number, and polymer used, the easier it will be to have the facing layers have similar tensile and elongation characteristics.

The nonwoven web layers of continuous fibers may desirably be produced by a spunbonding process as is known in the art, such as those disclosed in, for example, U.S. Pat. No. 4,340,563 to Appel et al. and U.S. Pat. No. 3,802,817 to Matsuki et al., herein incorporated by reference in their entireties, except for the particular process requirements as are noted below. Polymers suitable for producing nonwoven web layers of continuous filaments may be any of those known in the art, and include polyolefins, polyesters, polyamides, polycarbonates and copolymers and blends thereof. Suitable polyolefins include polypropylene, e.g., isotactic polypropylene, syndiotactic polypropylene, blends of isotactic polypropylene and atactic polypropylene; polyethylene, e.g., high density polyethylene, medium density polyethylene, low density polyethylene and linear low density polyethylene; polybutylene, e.g., poly(1-butene) and poly(2-butene); polypentene, e.g., poly(1-pentene) and poly(2-pentene); poly(3-methyl-1-pentene); poly(4-methyl-1-pentene); and copolymers and blends thereof. Suitable copolymers include random and block copolymers prepared from two or more different unsaturated olefin monomers, such as copolymers of ethylene or butylene in propylene. Suitable polyamides include nylon 6, nylon 6/6, nylon 4/6, nylon 11, nylon 12, nylon 6/10, nylon 6/12, nylon 12/12, copolymers of caprolactam and alkylene oxide diamine, and the like, as well as blends and copolymers thereof. Suitable polyesters include polylactide and polylactic acid polymers as well as polyethylene terephthalate, polybutylene terephthalate, polytetramethylene terephthalate, polycyclohexylene-1, 4-dimethylene terephthalate, and isophthalate copolymers thereof, as well as blends thereof. Selection of polymers for the fibers of the nonwoven web layers of continuous fibers is guided by end-use need, economics, and processability. The list of suitable polymers herein is not exhaustive and other polymers known to one of ordinary skill in the art may be employed.

The fibers of the nonwoven web layers of continuous fibers may be monocomponent fibers or multicomponent fibers, and may be uncrimped or crimped. Crimped multicomponent fibers are highly useful for producing bulky or lofty nonwoven fabrics and may desirably be used for applications where cloth-like aesthetics such as softness, drapability and hand are of importance. Multicomponent fiber production processes are known in the art. For example, U.S. Pat. No. 5,382,400 to Pike et al., herein incorporated by reference, discloses a suitable process for producing multicomponent fibers and webs thereof. In addition, it should be noted that the two nonwoven web layers of continuous fibers need not be identical and may utilize differing polymers or differing polymer types. As an example, where the nonwoven laminate material is a SMS material used for surgical gowns or other skin-contacting uses, the non-body side spunbond layer (that layer which will not be contacting the wearer's body) may comprise polypropylene fibers while the body-side spunbond layer (the layer worn closest to the wearer) may be a crimped multicomponent spunbond layer to impart added in-use comfort to the gown material. As another example, random copolymers of olefins such as an ethylenepropylene random copolymer (“RCP”) are known for producing nonwovens having a softer or more cloth-like feel and so one or more of the spunbond layers and particularly the body-side spunbond layer may desirably comprise monocomponent RCP spunbond fibers.

Where barrier layer 16 is a meltspun microfiber layer it may be for example a meltblown layer. The meltblowing process is well known in the art and will not be described in detail herein. Briefly, meltblowing involves extruding molten thermoplastic polymer through fine die capillaries as molten filaments or fibers. The molten fibers are extruded into converging streams of high velocity gas such as heated air streams to attenuate or draw down the fibers to a smaller diameter. The attenuated fibers are generally deposited on a collecting surface such as a foraminous forming belt or conveyor as a web in a random arrangement of fibers. Meltblowing is described, for example, in U.S. Pat. No. 3,849,241 to Buntin, U.S. Pat. No. 4,307,143 to Meitner et al., and U.S. Pat. No. 4,707,398 to Wisneski et al., all incorporated herein by reference in their entireties. The meltspun microfibers should be smaller than about 10 microns in average diameter, and desirably are smaller than about 7 microns in average diameter, and more desirably smaller than about 5 microns in average diameter. Additionally, the meltspun microfiber layer may comprise multicomponent microfibers as are known in the art such as bicomponent meltblown fibers.

Polymers suitable for producing meltblown microfiber layers may be any of those known in the art. More particularly, olefin polymers such as polypropylene, polyethylene and polybutylene, and mixtures of these polymers, are desirably used because they are relatively inexpensive and are desirable for their ease of processing. Where high barrier properties are desired the polymers used for making meltblown layers should be able to produce a meltblown web having a small average pore size and the polymers will advantageously have a high melt flow rate or “MFR” such as 1000 grams per 10 minutes or more. The melt flow rate of polymers may be determined by measuring the mass of molten thermoplastic polymer under a 2.060 kg load that flows through an orifice diameter of 2.0995+/−0.0051 mm during a specified time period such as, for example, 10 minutes at the specified temperature such as, for example, 177° C. as determined in accordance with test ASTM-D-1238-01, “Standard Test Method for Flow Rates of Thermoplastic By Extrusion Plastometer,” using a Model VE 4-78 Extrusion Plastometer available from Tinius Olsen Testing Machine Co., Willow Grove, Pa. An exemplary high melt flow polybutylene polymer is an ethylene copolymer of 1-butene having about 5% ethylene which has a melt flow rate of approximately 3000 grams per 10 minutes is available from Basell, USA, Inc. of Wilmington, Del. under the trade designation DP-8911. As is known in the art, high melt flow propylene polymers useful for producing microfiber layers (polymers having melt flow rates in excess of about 1000) may be provided by adding a prodegradant such as a peroxide to conventionally produced polymers such as those made by Ziegler-Natta catalysts in order to partially degrade the polymer to increase the melt flow rate and/or narrow the molecular weight distribution. Peroxide addition to polymer pellets is described in U.S. Pat. No. 4,451,589 to Morman et al. and improved barrier microfiber nonwoven webs which incorporate peroxides in the polymer are disclosed in U.S. Pat. No. 5,213,881 to Timmons et al.

More recently, high melt flow rate polymers have become available which have high melt flow rates as-produced, that is, without the need of adding prodegradants such as peroxides to degrade the polymer to decrease viscosity/increase melt flow rate. Thus, these high melt flow rate polymers are able to produce webs of fine microfibers having small average pore size and good barrier properties without the use of prodegradants.

Suitable high melt flow rate polymers can comprise polymers having a narrow molecular weight distribution and/or low polydispersity (relative to conventional olefin polymers such as those made by Ziegler-Natta catalysts) and include those catalyzed by “metallocene catalysts”, “single-site catalysts”, “constrained geometry catalysts” and/or other like catalysts. Examples of such catalysts and/or olefin polymers made therefrom are described in, by way of example only, U.S. Pat. No. 5,153,157 to Canich, U.S. Pat. No. 5,064,802 to Stevens et al., U.S. Pat. No. 5,374,696 to Rosen et al., U.S. Pat. No. 5,451,450 to Elderly et al., U.S. Pat. No. 5,204,429 to Kaminsky et al., U.S. Pat. No. 5,539,124 to Etherton et al., U.S. Pat. Nos. 5,278,272 and 5,272,236, both to Lai et al., and U.S. Pat. No. 5,554,775 to Krishnamurti et al. Exemplary polymers having a high melt flow rate, narrow molecular weight distribution and low polydispersity are disclosed in U.S. Pat. No. 5,736,465 to Stahl et al. and are available from Exxon Chemical Company under the trade name ACHIEVE.

For certain applications, such as for example for surgical and industrial protective wear, it may be important for the nonwoven laminate material to have repellency to low surface tension liquids such as alcohols, aldehydes, ketones and surfactant-containing liquids. Repellency to low surface tension liquids may be imparted to any or all of the layers of the nonwoven laminate material by use of topical or internal additives. Exemplary liquid repellency additives are fluorocarbon compounds which may be applied topically or internally via addition to the polymer melt from which the nonwoven fibrous layer or layers are produced. Where the additive is used internally it is desirably added to the polymer melt in an amount from about 0.1 weight percent to about 2 weight percent, and more desirably in an amount from about 0.25 to about 1.0 weight percent. As an example, the fluorocarbon compounds disclosed in U.S. Pat. No. 5,149,576 to Potts et al., herein incorporated by reference, and in U.S. Pat. No. 5,178,931 to Perkins et al., herein incorporated by reference, are well suited to providing liquid repellency properties to nonwoven fabrics. Where fluorocarbon compounds are used as internal additives to a meltblown layer the meltblown may desirably comprise a mixture of high melt flow rate polypropylene and about 5 percent to about 20 percent high melt flow rate polybutylene polymer.

As stated above, the nonwoven laminate material may desirably comprise a film layer acting as a barrier layer. As an example, a “breathable” film layer which is permeable to vapors or gas yet substantially impermeable to liquid, such as is known in the art can be laminated between the outer nonwoven web layers of continuous fibers to provide a breathable barrier laminate that exhibits a desirable combination of useful properties such as soft texture, strength and barrier properties. Generally speaking, film is considered “breathable” if it has a water vapor transmission rate of at least 300 grams per square meter per 24 hours (g/m2/24 hours), as calculated in accordance with ASTM Standard E96-80. Exemplary breathable film-nonwoven laminate materials are described in, for example, U.S. Pat. No. 6,037,281 to Mathis et al, herein incorporated by reference in its entirety.

Thermal pattern bonding devices as are known in the art and as are described above may be used to thermally point-bond or spot-bond the component layers together into the nonwoven laminate material. Alternatively, where the fibers are multicomponent fibers having component polymers with differing melting points, through-air bonders such as are well known to those skilled in the art may be advantageously utilized for bonding the continuous fiber outer nonwoven web layers. Generally speaking, a through-air bonder directs a stream of heated air through the web of continuous multicomponent fibers thereby forming inter-fiber bonds by desirably utilizing heated air having a temperature at or above the polymer melting temperature of the lower melting polymer component and below the melting temperature of higher melting polymer component. As still other alternatives, the component webs and/or laminate may be bonded by utilizing other means as are known in the art such as for example adhesive bonding means or ultrasonic bonding means.

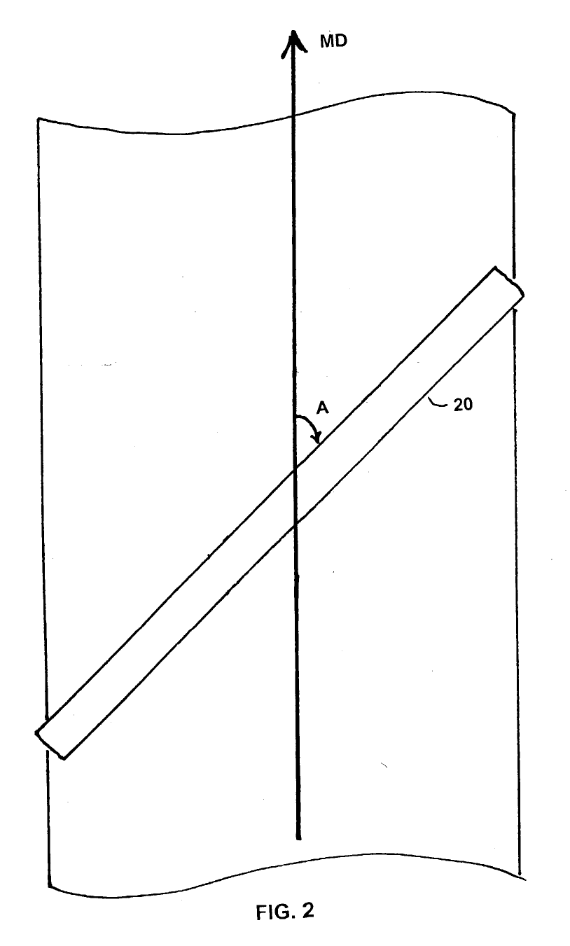

The nonwoven laminate material of the invention has high uniformity of properties throughout all directions in the plane of the laminate. For example, the nonwoven laminate material has essentially equal tensile strength for all directions taken within the plane of the laminate. Turning to FIG. 2, there is illustrated in schematic form a top plan view of a portion of an exemplary process for making a laminate having high uniformity of properties, which demonstrates the orientation of the source of continuous fibers, that is, the fiber production apparatus, with respect to the MD or direction of material production. As shown in FIG. 2, the direction of material production or MD is shown by arrow MD. Using the MD direction as the origin or zero degrees and measuring angles by going clockwise, the fiber production apparatus 20 is oriented at less than 90 degrees with respect to the MD, rather than being oriented at 90 degrees, and the fiber production apparatus shown here in FIG. 2 is oriented at angle A of approximately 45 degrees. Desirably, the fiber production apparatus will be oriented from about 30 degrees to about 60 degrees with respect to the MD, in order to avoid producing a web having a high degree of MD fiber directionality, which as stated results in nonwoven webs having an undesirable degree of MD directionality with respect to tensile strengths rather than webs having uniform strength properties.

The apparatus illustrated in FIG. 2 may be used to produce the laminate materials of the invention by producing a web of continuous fibers which is then bonded and rolled up on a winder as is known in the art. Then, a second roll of continuous fiber web material is made. The two continuous fiber webs may then be unwound from their respective rolls by mounting the rolls on material unwinds or spindles as are known in the art and directing the webs to a bonding device to bond them together into a multi-layer laminate material. However, in order to realize the benefits of the invention, one of the continuous fiber webs must be inverted with respect to its original 45 degree production orientation as is described in the Examples below. Inverting one of the webs may be accomplished by the expedient of turning one roll around so that when mounted on the spindles, one web of continuous fibers unwinds from the top of the material roll while the other web unwinds from the bottom of its respective material roll. Where it is desirable to produce a barrier nonwoven laminate material, one or more layers of barrier material may also be unwound between the two webs of continuous fibers prior to bonding all the layers together to form a laminate material.

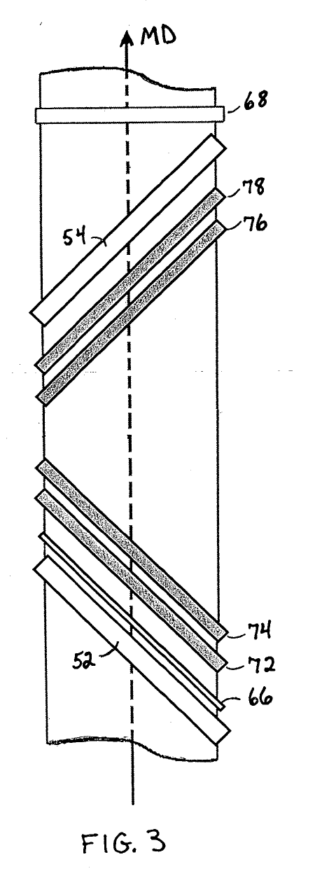

Turning to FIG. 3 there is illustrated in schematic form a top plan view of an exemplary process for making a barrier laminate embodiment of the nonwoven laminate material of the invention. In reference to FIG. 3, the process is arranged as an in-line process to produce multi-layer nonwoven webs known in the art as spunbond-meltblown-spunbond (SMS) nonwoven webs. In FIG. 3 the direction of material production or MD is shown by arrow MD. The process as shown includes two sources of continuous fibers as first spunbond spinneret 52 and second spunbond spinneret 54, and four banks of meltblown dies 72, 74, 76 and 78 disposed between first spunbond spinneret 52 and second spunbond spinneret 54. Rather than being oriented at 90 degrees with respect to the MD, first spunbond spinneret 52 is at an angle between about 300 and about 330 degrees, and as shown in FIG. 3 first spunbond spinneret 52 is oriented at approximately 315 degrees with respect to the MD direction. Second spunbond spinneret 54 is oriented at an angle between about 30 and about 60 degrees with respect to the MD, and as shown here in FIG. 3 second spunbond spinneret 54 is oriented at approximately 45 degrees with respect to the MD direction. Note that these could be reversed, that is, first spinneret 52 could be oriented at 30 to 60 degrees with second spinneret 54 oriented at 300 to 330 degrees. Meltblown dies 72 and 74 are shown oriented at approximately the same angle as first spinneret 52, that is, at approximately 315 degrees, while meltblown dies 76 and 78 are shown oriented at approximately the same angle as second spinneret 54 at an angle of approximately 45 degrees with respect to the MD. For the specific case where the first and second spunbond spinnerets are oriented at 315 degrees and 45 degrees, respectively, the two spinnerets will be oriented approximately 90 degrees away from each other.

Note the angle selected for fiber production apparatus orientation will often desirably be about 45 degrees and about 315 degrees; however it may be necessary to adjust these angles for optimal uniformity of properties depending on process variables. Particularly, line speed (the speed at which the nonwoven laminate material is produced) may affect the angle necessary to produce uniform properties. Using second continuous fiber spinneret 54 as an example, for lower line speeds having the fiber production apparatus at 45 degrees or more may produce the desired uniformity of web properties. However, for higher line speeds it may be necessary to reduce the angle from 45 degrees to 40 degrees or even smaller angles. While not wishing to be bound by theory, we believe this is because of the effects of air entrained with a moving forming surface upon which the fibers are deposited as a web. The entrained air will tend to cause fiber orientation or alignment in the direction the air is moving (the MD) to a greater or lesser amount. As the line speed is increased, the speed of the air entrained with the forming surface also increases and begins to impart a greater MD alignment to the fibers. Reducing the angle of the fiber production apparatus from 45 degrees for higher line speed production will help overcome this effect.

Meltblown dies 72, 74, 76 and 78 may be any meltblown dies as are well known to those of ordinary skill in the art and thus will not be described here in detail. Generally described, a meltblown process includes forming fibers by extruding a molten thermoplastic material through a plurality of fine, usually circular, die capillaries as molten threads or fibers into converging high velocity gas (e.g. air) streams which attenuate the fibers of molten thermoplastic material to reduce their diameter. Thereafter, the meltblown fibers are carried by the high velocity gas stream and are deposited on a collecting surface to form a web of randomly dispersed meltblown fibers. Such a process is disclosed, for example, in U.S. Pat. No. 3,849,241 to Buntin. Meltblown fibers may be continuous or discontinuous, are generally smaller than 10 microns in diameter, and are generally tacky when deposited onto a collecting surface. An exemplary apparatus and process for forming meltblown fibers is described in U.S. Pat. No. 6,001,303 to Haynes et al., herein incorporated in its entirety by reference.

Turning again to FIG. 3, there is shown located between first spinneret 52 and meltblown die 72 a consolidation means 66 such as for example an air knife blowing heated air into and through the web of fibers which is formed from first spinneret 52. Such an air knife is described in U.S. Pat. No. 5,707,468 to Arnold, et al., incorporated herein by reference. Consolidation means 66 acts to initially or preliminarily consolidate the nonwoven web formed from first spinneret 52 to protect it from disruption by the high velocity gas streams at meltblowing processes 72, 74, 76 and 78. Consolidation means 66 may also desirably be a compaction roller as is known in the art. However, where consolidation means 66 is a compaction roller it would typically be oriented at about 90 degrees with respect to the MD rather than as shown in FIG. 3 at an angle parallel to spinneret 52. The process also includes a consolidation means 68 to initially or preliminarily consolidate those portions or layers of the web added subsequent to first spinneret 52. Initial or preliminary consolidation means 68 may desirably be a compaction roll located downstream (later in terms of material process) from second spinneret 54.

Although the process illustrated in FIG. 3 is configured with two banks of spunbond spinnerets and four banks of meltblown dies, it will be appreciated by those skilled in the art that these numbers could be varied without departing from the spirit and scope of the invention. As an example, either fewer or more meltblown die banks could be utilized, or multiple continuous fiber spinnerets may be used in the first spinneret or second spinneret positions, or both. In addition, it will be appreciated by those skilled in the art that various other process steps and/or parameters could be varied in numerous respects without departing from the spirit and scope of the invention. For example, some or all of the layers of the nonwoven laminate material may be made individually and separately and wound up on rolls, and then combined into the multilayer nonwoven laminate material as a separate step. Alternatively, the two outer nonwoven layers may be formed at spunbond spinneret banks 52 and 54 as shown in FIG. 3 while a pre-formed barrier layer such as for example a meltblown microfiber layer is unwound between them, instead of using the meltblown die banks 72, 74, 76 and 78. In this regard, it is important to note that the majority of the strength characteristics of the nonwoven laminate material are provided by the continuous fiber facing layers rather than by the barrier material layer, and therefore the barrier layer may be produced from apparatus conventionally oriented at 90 degrees to the MD rather than oriented as shown in FIG. 3. However, orientation of the barrier material production apparatus as shown in FIG. 3 does advantageously provide the same benefits of optionally high production rates or finer fiber production as described below with respect to the continuous fiber webs.

As an example of additional process steps, it is known in the art to subject fibers to electrostatic charging during the production process to improve overall nonwoven web uniformity. Electrostatic charging may be especially useful in reducing the effects of entrained air at higher production line speeds, as was described above. Generally described, an electrostatic charging device consists of one or more rows of electric emitter pins which produce a corona discharge, thereby imparting an electrostatic charge to the fibers, and the fibers, once charged, will tend to repel one another and help prevent groups of individual fibers from clumping or “roping” together. An exemplary process for charging fibers to produce nonwovens with improved fiber distribution is disclosed in PCT publication WO 02/52071 to Haynes et al., published Jul. 4, 2002, incorporated herein by reference in its entirety.

In addition, the present process provides for either production of nonwoven webs at very high production rates, or production of finer fiber web layers at typical web production rates. As a specific example of increased rate of production, the continuous fiber spinnerets illustrated in FIG. 2 and FIG. 3 are shown oriented at angles which, as shown, are approximately 45 degrees and/or approximately 315 degrees with respect to the MD. Because the hypotenuse of a 45-45-90 triangle is the square root of 2 times the length of a side, these spinnerets are therefore approximately [2]^{1/2} or 1.41 times longer (for the same CD width of material made) than would be spinnerets conventionally oriented at 90 degrees to the MD would be. In this instance the rate of nonwoven web production would be approximately 1.41 times greater than for a process with conventional 90 degree oriented spinnerets, where spinneret capillary spacing and spinneret capillary per-hole polymer extrusion rate are the same for the two processes. Larger or smaller angles will result in either lower or higher production rates, respectively, than the case for an angle equal to 45 degrees, but for the same capillary spacing and throughput the production rate will always be higher than for a conventional 90 degree oriented process.

One method known in the art for producing finer fibers is to reduce capillary per-hole extrusion rates, but this also decreases the overall material production rate. The process of the invention may be used to make finer fiber webs at typical web production rates. For the specific example wherein the spinnerets are oriented at approximately 45 and 315 degrees as described above the capillary per-hole polymer extrusion rate would be decreased to approximately 71% of (or [2]⁻1/2 times) the per-hole extrusion rate of a conventional process with 90 degree oriented spinnerets, where the nonwoven web production rate and spinneret capillary spacing are the same for the two processes. Therefore with the process of the invention it is possible to reduce per-hole extrusion rate, thus enabling finer fibers, without sacrificing the overall nonwoven web production rates as would be required in a conventional process oriented at 90 degrees with respect to the MD. Finer fibers are often desirable for improved web cloth-like attributes and softness, and improved web layer uniformity and overall strength.

While not described herein in detail, various additional potential processing and/or finishing steps known in the art such as web slitting, stretching or treating may be performed without departing from the spirit and scope of the invention. Examples of web treatments include electret treatment of the laminate to induce a permanent electrostatic charge in the laminate material, or in the alternative antistatic treatments. Antistatic treatments may be applied topically by spraying, dipping, etc., and an exemplary topical antistatic treatment is a 50% solution of potassium N-butyl phosphate available from the Stepan Company of Northfield, Ill. under the trade name ZELEC. Another exemplary topical antistatic treatment is a 50% solution of potassium isobutyl phosphate available from Manufacturer's Chemical, LP, of Cleveland, Tenn. under the trade name QUADRASTAT. Another example of web treatment includes treatment to impart wettability or hydrophilicity to a web comprising hydrophobic thermoplastic material. Wettability treatment additives may be incorporated into the polymer melt as an internal treatment, or may be added topically at some point following fiber or web formation.

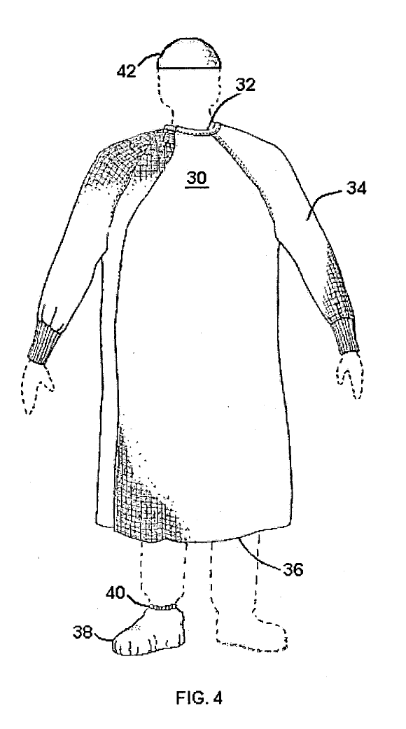

The nonwoven laminate material of the present invention is highly suitable for various uses, for example, uses including disposable protective articles such as protective fabrics, fabrics for medical products such as patient gowns, sterilization wraps and surgical drapes, gowns, face masks, head and shoe coverings, and fabrics for other protective garments such as industrial protective wear. Exemplary medical products are shown schematically in FIG. 4 on a human outline represented by dashed lines. As illustrated in FIG. 4, gown 30 is a loose fitting garment including neck opening 32, sleeves 34, and bottom opening 36. Gown 30 may be fabricated using the nonwoven laminate material of the invention. Also shown on the human outline in FIG. 4 is shoe covering 38 having opening 40 which allows the cover to fit over the foot and/or shoe of a wearer. Shoe covering 38 may be fabricated using the nonwoven laminate material of the invention. Additionally shown in FIG. 4 is head covering 42, such as a surgical cap, which may be fabricated using the nonwoven laminate material of the invention.

The following examples are provided for illustration purposes and the invention is not limited thereto.

### EXAMPLES

Separately produced rolls of polypropylene spunbond and meltblown nonwoven materials were unwound and laminated together using thermal point bonding to form SMS laminate materials. The spunbond web material was produced at various basis weights using fiber forming apparatus (i.e., the fiber extrusion and drawing equipment) which was oriented at approximately 45 degrees with respect to the MD. Two rolls of each basis weight of the spunbond material were produced as paired rolls to be laminated to either side of the 0.4 osy (13.6 gsm) meltblown material. In order to produce the nonwoven laminate materials of the invention, one roll of each pair of spunbond rolls was unwound toward the laminating point bonder in the opposite direction or in such a fashion that one spunbond web was inverted or upside down with respect to its original 45 degree production orientation. This simulated the exemplary process description above wherein one web layer of continuous fibers is produced from extrusion and drawing apparatus having an orientation of about 45 degrees while the other web layer of continuous fibers is produced from apparatus having an orientation of about 315 degrees. By way of further explanation, when the rolls of spunbond material were produced they were formed on a foraminous forming surface or “forming wire” and therefore the spunbond web as-formed had a top side surface and a wire side surface (the bottom of the spunbond material as formed, that is, the surface of the material contacting the forming wire). Where the materials are laminated to form a SMS laminate without inverting one of the continuous fiber webs the interposed barrier material will contact the top side surface of one continuous fiber web and the bottom or wire side surface of the other continuous fiber web. However, when one of the webs of continuous fibers is inverted, the interposed barrier material will contact either the top side surface of both webs of continuous fibers or the wire side surface of both webs. Inverting one of the webs may be accomplished by the expedient of turning one roll around so that when mounted on the material roll unwinds or spindles, one web of continuous fibers unwinds from the top of the material roll while the other web unwinds from the bottom of its material roll.

Commercially available comparative laminate materials and experimental laminate materials were tested as described below to assess the laminate materials' uniformity of tensile strength for directions throughout the plane of the material. Comparative laminate material C1 was ATI Super Duty, a SMS laminate which is available from American Threshold, Inc. of Enka, N.C. Comparative laminate materials C2, C3, C4 and C5 were, respectively, KIMGUARD® Heavy Duty, KIMGUARD® Midweight, SPUNGUARD® Super Duty and SPUNGUARD® Regular, which are SMS laminate materials available from the Kimberly-Clark Corporation of Irving, Tex.

Test method: 180 Degree Grab Tensile Strength Testing.

Tensile strength testing was performed as grab tensile strengths in accordance with ASTM D5034-90. Rectangular 100 mm by 150 mm samples to be tested for grab tensile were taken from each of the materials. In order to assess uniformity of tensile strength throughout a range of directions, sampling sites were selected across a 180 degree arc of the materials as follows. Twelve sampling directions were selected such that the long dimension of the sample was parallel to a specific desired direction with regard to the MD or direction of material production. The first sample direction was selected such that its long dimension was parallel to the CD direction, that is, in a direction 90 degrees from the MD. Each subsequent sampling direction was selected so that the sample would have its long dimension parallel to a direction 15 degrees from the previous sample, so that the 12 sampling directions selected for testing were aligned at (respectively and with regard to the MD) 90, 75, 60, 45, 30, 15, 0 (MD), −15, −30, −45, −60 and −75 degrees. Ten repetitions of the tensile strength test were performed for each of the 12 designated sampling directions for all of the comparative laminates and most of the experimental laminates. Due to limited material availability for experimental laminate materials E1, E2 and E3 fewer repetitions (4, 5 and 9 repetitions, respectively) were performed. The results for the repetitions for each sampling direction were averaged, and then the overall average tensile strength result (“Avg”) for each laminate material was calculated as the average tensile strength result for all 12 sampling directions. The standard deviation (“SD”) between the tensile strength results for the 12 sampling directions was calculated. The standard deviation was then expressed as a percentage of the overall average, as the variation (“V”) in tensile strength between the 12 sampling directions and was calculated as V=100%(SD/Avg). These results are shown in TABLE 1.

TABLE 1

| | Weight | Tensile | Tensile | Tensile |
|---|---|---|---|---|
| Example | (gsm) | Avg (kg) | SD (kg) | V (%) |
| C1 | 74.6 | 15.34 | 2.91 | 19.0 |
| C2 | 73.6 | 14.92 | 1.10 | 7.4 |
| C3 | 59.6 | 12.05 | 1.09 | 9.1 |
| C4 | 68.4 | 14.07 | 1.68 | 11.9 |
| C5 | 40.4 | 6.32 | 0.53 | 8.3 |
| E1 | 80.0 | 19.31 | 0.76 | 3.9 |
| E2 | 76.6 | 17.20 | 0.67 | 3.9 |
| E3 | 76.6 | 21.22 | 0.81 | 3.8 |
| E4 | 75.6 | 20.56 | 0.55 | 2.7 |
| E5 | 74.9 | 21.52 | 0.47 | 2.2 |
| E6 | 70.5 | 18.62 | 0.76 | 4.1 |
| E7 | 61.4 | 16.62 | 0.47 | 2.8 |
| E8 | 47.5 | 12.30 | 0.66 | 5.4 |
| E9 | 37.6 | 9.51 | 0.53 | 5.6 |

As can be seen in TABLE 1, comparative commercially available laminate materials demonstrate significant non-uniformity with respect to directional tensile strength testing, with variation V ranging from 7.4 percent to as high as 19 percent. However, for the laminate materials of the invention which compare to these commercially available materials the variation V values are much lower, generally 6 percent or less, and often less than 5 percent or even less than 4 percent.

Numerous other patents have been referred to in the specification and to the extent there is any conflict or discrepancy between the teachings incorporated by reference and that of the present specification, the present specification shall control. Additionally, while the invention has been described in detail with respect to specific embodiments thereof, it will be apparent to those skilled in the art that various alterations, modifications and/or other changes may be made without departing from the spirit and scope of the present invention. It is therefore intended that all such modifications, alterations and other changes be encompassed by the claims.

We claim:

1. A nonwoven laminate material comprising a first web layer of substantially continuous fibers and a second web layer of substantially continuous fibers bonded to form a laminate, said nonwoven laminate material having essentially equal tensile strength in any direction taken within the plane of said nonwoven laminate material.

2. The nonwoven laminate material of claim 1 further comprising at least one layer of barrier material interposed in face to face relation between and bonded to said first web layer of substantially continuous fibers and said second web layer of substantially continuous fibers.

3. The nonwoven laminate material of claim 2 wherein said barrier layer is a film layer.

4. The nonwoven laminate material of claim 3 wherein said barrier layer is a breathable film layer.

5. The nonwoven laminate material of claim 2 wherein said barrier layer is at least one web layer of meltspun microfibers, said microfibers being of less than about 10 microns in average diameter.

6. The nonwoven laminate material of claim 4 comprising olefin polymer selected from the group consisting of polymers and copolymers of olefins.

7. The nonwoven laminate material of claim 5 comprising olefin polymer selected from the group consisting of polymers and copolymers of olefins.

8. The nonwoven laminate material of claim 5 wherein said first and second continuous fiber nonwoven web layers are spunbond webs and wherein said at least one meltspun microfiber web layer is at least one meltblown web layer.

9. The nonwoven laminate material of claim 8 wherein said spunbond webs and said at least one meltblown web comprise olefin polymer selected from the group consisting of polymers and copolymers of propylene, ethylene and butylene and blends thereof.

10. The nonwoven laminate material of claim 9 wherein said meltblown web further comprises a fluorocarbon compound additive.

11. The nonwoven laminate material of claim 10 wherein at least one of said spunbond webs comprises a fluorocarbon compound additive.

12. The nonwoven laminate material of claim 9 wherein at least one of said spunbond webs further comprises a topical antistatic treatment.

13. A surgical gown comprising the nonwoven laminate material of claim 4.

14. A surgical gown comprising the nonwoven laminate material of claim 10.

15. A surgical drape comprising the nonwoven laminate material of claim 4.

16. A surgical drape comprising the nonwoven laminate material of claim 5.

17. A sterilization wrap material comprising the nonwoven laminate material of claim 4.

18. A sterilization wrap material comprising the nonwoven laminate material of claim 5.

19. A protective workwear garment comprising the nonwoven laminate material of claim 4.

20. A protective workwear garment comprising the nonwoven laminate material of claim 5.

21. A face mask comprising the nonwoven laminate material of claim 5.

22. A process for forming a multi-layer nonwoven laminate material comprising the steps of:
a) providing a first plurality of continuous fibers from a first source of continuous fibers and second plurality of continuous fibers from a second source of continuous fibers, said first source oriented at an angle of about 300 to about 330 degrees with respect to the MD direction and said second source oriented at an angle of about 30 to about 60 degrees with respect to the MD direction;
b) providing at least one layer of barrier material;
c) collecting said first plurality of continuous fibers, said barrier material and said second plurality of fibers on a moving forming surface to form a multi-layer nonwoven material wherein said at least one layer of barrier material is disposed between said first and second plurality of continuous fibers; and thereafter
d) bonding said multi-layer nonwoven material together to form the multi-layer nonwoven laminate material.

23. The process of claim 22 further comprising the step of electrostatically charging at least one of said first and second plurality of continuous fibers prior to the step of collecting said continuous fibers on said moving forming surface.

24. The process of claim 23 wherein said at least one layer of barrier material is provided by a first meltblown die disposed between said first and second sources of continuous fibers and wherein said first meltblown die is oriented at an angle of about 300 degrees to about 330 degrees with respect to the MD direction.

25. The process of claim 23 wherein said at least one layer of barrier material is provided by at least one meltblown die disposed between said first and second source of continuous fibers and wherein said at least one meltblown die is oriented at an angle of about 90 degrees with respect to the MD direction.

26. The process of claim 24 further comprising providing a second layer of barrier material provided by a second meltblown die, said second meltblown die disposed between said first meltblown die and said second source of continuous fibers and wherein said second meltblown die is oriented at an angle of about 30 degrees to about 60 degrees with respect to the MD direction.

27. The process of claim 23 wherein said at least one layer of barrier material is provided by unwinding meltblown material from a roll of meltblown material.

28. The process of claim 23 wherein said first source of continuous fibers is oriented at about 315 degrees with respect to the MD direction and said second source of continuous fibers is oriented at an angle of about negative 45 degrees with respect to the MD direction.

29. A process for forming a multi-layer nonwoven laminate material comprising the steps of:
a) providing a first web of continuous fibers and a second web of continuous fibers, said first and second webs each having been formed from fiber forming apparatus oriented at an angle with respect to the MD direction selected from the group consisting of about 30 degrees to about 60 degrees and about 300 degrees to about 330 degrees;
b) inverting one of said first web and said second web;
c) providing at least one layer of barrier material disposed between said first web and said second web; and thereafter d) bonding said first web, said barrier material and said second web together to form the multi-layer nonwoven laminate material.

30. The process of claim 29 wherein said at least one layer of barrier material is a breathable film layer.

31. The process of claim 29 wherein said at least one layer of barrier material is a meltblown layer.
